(19) United States
(12) Patent Application Publication
(10) Pub. No.: US 2001/0007211 A1
(43) Pub. Date: Jul. 12, 2001

(54) Shift lever cover for shoe protection

(76) Inventor: Godfrey J. Allert, Downsview (CA)

Correspondence Address: Mark B. Eisen, c/o Dimock Stratton Clarizio, Suite 3202, Box 102, 20 Queen Street West, Toronto, ON, M5H 3R3, CA

(21) Appl. No.: 09/746,445

(22) Filed: Dec. 26, 2000

(30) Foreign Application Priority Data
Jan. 6, 2000 (CA) 2,294,682

(51) Int. Cl. G05G 13/00; G05G 1/04

(52) U.S. Cl. 74/478; 74/558.5

(57) ABSTRACT

The present invention provides a protective covering accessory for use on a shift lever of a motorcycle or all terrain vehicle. The accessory comprises a layer of polymeric material applied to at least the underside of the shift lever, the layer of polymeric material having rounded edges and the polymeric material being relatively soft so as to prevent damage to footwear of a user of the motorcycle or all terrain vehicle. Preferably, the accessory is in the form of a cylinder and is fitted over the shift lever.

### FIELD OF THE INVENTION

This invention relates to a new vehicle accessory, and in particular to a shift lever cover to protect the shoe of the user of the shift lever where the shift lever is operated by the user's foot.

### BACKGROUND OF THE INVENTION

In many motorcycle and all terrain vehicles made and sold today, the shift levers are made of metal and are accessed by a user using its feet. The user must press the shift lever down and in some instances, move the lever up, using his or her foot. In order to move the lever up, the upper part of the user's foot is used and comes into contact with the underside of the shift lever.

This repeated contact between the upper part of the shoe and the lever results in excessive wear and tear of the shoe. In particular, after some use, the rubbing and friction on the shoe will wear out the shoe. This can cause pain and fatigue to the upper part of the user's foot.

This problem has been addressed in the past in two ways. First, manufacturers of motorcycle and all terrain vehicles have added a rubber piece to the shift lever. However, this rubber piece only provides minimal protection against wear and tear of the user's shoe because its main purpose is to add friction or “grip” to the lever so as to prevent accidental slippage when accessing the lever.

The second solution used in the past is to provide a protector to be placed on the user's shoe. This protector was intended to be attached to the user's shoe and protect the upper part and toe area of the shoe. Hence, this solution was to provide the user with an accessory for the user's footwear. However, a significant drawback is that the user must constantly remove and reinstall this protector when he or she changes footwear. The problem of providing effective protection for the user's shoes therefore still remains.

### SUMMARY OF THE INVENTION

Accordingly, in one aspect of the present invention, there is provided a protective covering accessory for use on a foot-operated shift lever of a vehicle, comprising a layer of polymeric material applied to at least the underside of the shift lever, the polymeric material being relatively soft so as to prevent damage to the footwear of a user of the vehicle. Preferably, the layer of polymeric material has rounded edges, and in a one embodiment of the present invention, the protective covering is in the form of a cylinder that be slipped on and off the shift lever.

### BRIEF DESCRIPTION OF THE DRAWINGS

The preferred embodiments of the present invention will be described with reference to the accompanying drawings in which like numerals refer to the same parts in the several views and in which:

FIG. 1 is a general view of a typical motorcycle;

FIG. 2 is a perspective view of one embodiment of the protective accessory of the present invention.

### DETAILED DESCRIPTION OF THE PREFERRED EMBODIMENTS

The present invention will be described with reference to its preferred embodiments and with reference to the use of the protective accessory with the shift lever of a motorcycle. It will be readily apparent to the person skilled in the art, however, that the protective accessory can be used on any vehicle where the shift lever is foot-operated, such examples can include, but are not limited to, motorcycles or all terrain vehicles.

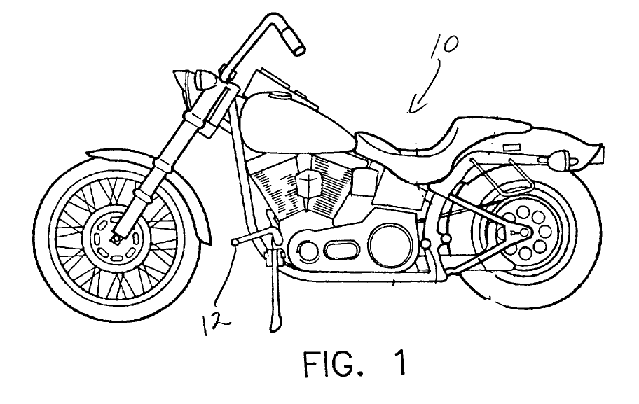

Referring to FIG. 1, there is shown a typical motorcycle 10 comprising a shift lever 12. The shift lever 12 is generally accessed by the user's foot. During operation of the motorcycle 10, the user must either press down on the lever 12, or lift the lever 12, up using his or her foot. During lifting of the lever 12, the upper part of the user's shoe comes into contact with the underside of the lever 12. During repeated use, the upper part of the shoe will become worn.

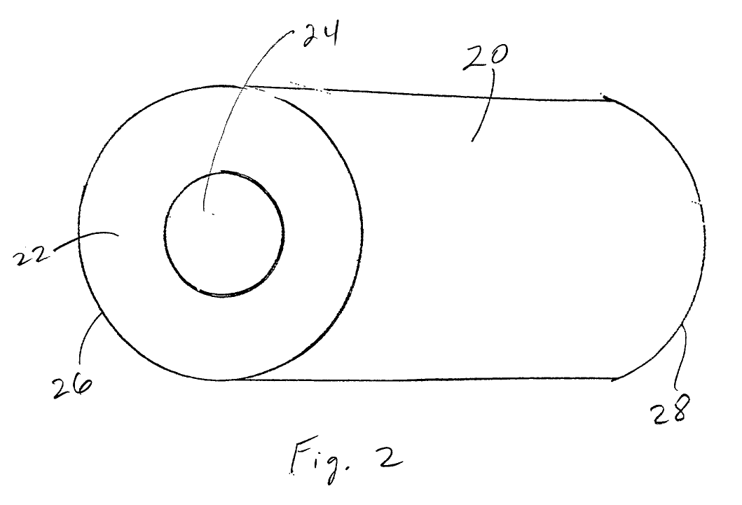

Referring to FIG. 2, there is shown a protective covering accessory 20 for use on the shift lever 12 of the motorcycle 10 or any other vehicle with a foot operated shift lever. The protective covering accessory 20 comprises a layer 22 of polymeric material applied to at least the underside of the shift lever 12. Since the wear and tear of the shoe occurs by contact with the underside of the lever 12, only that part must be covered. However, in a preferred embodiment, the accessory 20 is generally in the form of a cylinder so as to cover the entire surface of the lever 12. Preferably, the layer 22 of polymeric material has rounded edges (in the case of a cylindrical shape, the layer 22 is completely round), which will further help in protecting the upper part of the user's shoes.

The polymeric material used to make the accessory 20 is relatively soft so as to prevent damage to the footwear of the user of the motorcycle 10. The material should not be so soft and fragile as to wear out quickly, however, it should be such as to prevent wear and tear of the user's shoes. Preferably, the polymeric material is also water and heat resistant since the accessory 20 will be subject to somewhat harsh conditions during use. The polymeric material used for making the accessory 20 can be any material that provides these properties, and preferably the material is selected from the group consisting of: polystyrene, foam rubber, polyvinyl chloride and polyurethane, and combinations thereof.

In a preferred embodiment, the protective covering accessory 20 is in the form of a cylinder and the layer 22 of polymeric material has a thickness in the range of 0.040 inches to 3.40 inches, and preferably in the range of 0.080 inches to 0.110 inches. The central core 24 of the accessory 20 has a diameter in the range of 0.080 inches to 6 inches, and preferably a diameter of 0.750 inches. In this embodiment, one end 26 of the accessory 20 should always be open whereas the second end 28 is optionally open or closed. The accessory 20 is used by fitting it over the shift lever 12. It will be understood by persons skilled in the art that the exact shape and size of the accessory 20 can be varied to accommodate varying shapes and sizes of levers.

It will also be understood by persons skilled in the art that the protective covering accessory 20 could also be used in association with a brake pedal which may also be made of metal and operated by the user's foot.

In summary, some of the advantages of the protective accessory 20 of the present invention and of its various embodiments include the following (which are not intended to be exhaustive):

protects the upper part of the user's shoe from damage when shifting gears;

prevents wear and tear, such as scratching and scuffing, of the upper part of the user's shoes;

helps prevent slipping when the user accesses the shift lever;

provides more comfort for the user when shifting gears;

provides the user with protection of all the user's shoes; and

protects the shift lever pegs from unnecessary wear and tear and provides a protective cushion for the pegs.

Although the present invention has been shown and described with respect to its preferred embodiments, it will be understood by those skilled in the art that other changes, modifications, additions and omissions may be made without departing from the substance and the scope of the present invention as defined by the attached claims.

What is claimed is:

1. A protective covering accessory for use on a foot-operated shift lever of a vehicle, comprising a layer of polymeric material applied to at least the underside of the shift lever, the polymeric material being relatively soft so as to prevent damage to the footwear of a user of the vehicle.

2. The protective covering accessory of claim 1, wherein the layer of polymeric material is applied around the entirety of the shift lever.

3. The protective covering accessory of claim 1, wherein the polymeric material is water and heat resistant.

4. The protective covering accessory of claim 2, wherein the accessory is cylindrical in shape.

5. The protective covering accessory of claim 1, wherein the polymeric material is selected from the group consisting of: polystyrene, foam rubber, polyvinyl chloride and polyurethane, and combinations thereof.

6. The protective covering accessory of claim 2, wherein the polymeric material is selected from the group consisting of: polystyrene, foam rubber, polyvinyl chloride and polyurethane, and combinations thereof.

7. The protective covering accessory of claim 1, wherein the layer of polymeric material has a thickness in the range of 0.040 inches to 3.50 inches.

8. The protective covering accessory of claim 2, wherein the layer of polymeric material has a thickness in the range of 0.040 inches to 3.50 inches.

9. The protective covering accessory of claim 7, wherein the layer of polymeric material has a thickness in the range of 0.080 inches to 0.110 inches.

10. The protective covering accessory of claim 8, wherein the layer of polymeric material has a thickness in the range of 0.080 inches to 0.110 inches.

11. The protective covering accessory of claim 4, wherein the layer of polymeric material has a thickness in the range of 0.040 inches to 3.50 inches and the central core of the cylindrical accessory has a diameter in the range of 0.080 inches to 6.0 inches.

12. The protective covering accessory of claim 10, wherein the layer of polymeric material has a thickness in the range of 0.080 inches to 0.110 inches and the central core of the cylindrical accessory has a diameter of 0.750 inches.

13. The protective covering accessory of claim 1, wherein the layer of polymeric material has rounded edges.

14. A protective covering accessory for use on a brake pedal of a vehicle, comprising a layer of polymeric material, the polymeric material being relatively soft so as to prevent damage to the footwear of a user of the vehicle.
